(19) United States
(12) Patent Application Publication
(10) Pub. No.: US 2013/0262070 A1
(43) Pub. Date: Oct. 3, 2013

(54) SYSTEM AND METHOD FOR SUBSURFACE RESERVOIR CHARACTERIZATION

(71) Applicants: Paul Daniel Vincent, Houston, TX (US); Steven Alvin Bahret, Katy, TX (US); Louis Paul Herbert, The Woodlands, TX (US)

(72) Inventors: Paul Daniel Vincent, Houston, TX (US); Steven Alvin Bahret, Katy, TX (US); Louis Paul Herbert, The Woodlands, TX (US)

(73) Assignee: Chevron U.S.A. Inc., San Ramon, CA (US)

(21) Appl. No.: 13/434,909

(22) Filed: Mar. 30, 2012

(51) Int. Cl. G06G 7/48

(52) U.S. Cl. 703/10

(57) ABSTRACT

A system and computer-implemented method for characterizing a subsurface reservoir is presented. The method includes receiving seismic data and at least one migration velocity model representative of the subsurface reservoir and well logs representative of a geologic region similar to the subsurface reservoir; analyzing the well logs to determine regional trends that differentiate at least two of porous sands, cemented sands, and shales; inverting the seismic data to obtain a p-impedance model and an s-impedance model; predicting a gross sand volume from a ratio of the p-impedance to the s-impedance; and determining a porous sand volume from the gross sand volume through a depth dependent cutoff for cemented sand p-impedance values.

### TECHNICAL FIELD

The present invention relates generally to methods and systems for characterizing subsurface reservoirs, and in particular methods and systems for delineating cemented and porous sands within a subsurface reservoir using seismic data and well logs.

### BACKGROUND OF THE INVENTION

Hydrocarbon reservoirs are often located in sandstone formations. The ability to produce hydrocarbons from these reservoirs is linked to the permeability and porosity of the sands. The sands in the sandstone may be cemented, meaning that minerals have been deposited between the sand grains, reducing the porosity and permeability. The sands may be porous, meaning that the pore space between the sand grains is open and available to both hold hydrocarbons and allow hydrocarbons to flow through. Cemented sands may occur randomly within porous sand packages or shale packages and are not always thick enough to be discernable as individual members at seismic data resolution. In order to determine the amount of hydrocarbons in a reservoir and the ability to produce the hydrocarbons, it is necessary to be able to determine if the sands in the reservoir are cemented or porous.

### SUMMARY OF THE INVENTION

According to one implementation of the present invention, a computer-implemented method for characterizing a subsurface reservoir is presented. The method includes receiving seismic data and at least one migration velocity model representative of the subsurface reservoir and well logs representative of a geologic region similar to the subsurface reservoir; analyzing the well logs to determine regional trends that differentiate at least two of porous sands, cemented sands, and shales; inverting the seismic data to obtain a p-impedance model and an s-impedance model; determining a gross sand volume from a ratio of the p-impedance model to the s-impedance model and a first depth dependent cutoff; and determining a porous sand volume from the gross sand volume through a second depth dependent cutoff for cemented sand p-impedance values, wherein the porous sand volume represents the volume of the subsurface reservoir that may contain recoverable fluids.

In an embodiment, wherein the recoverable fluids are hydrocarbons, the method may further include using the porous sand volume to calculate hydrocarbon reserves and/or making well placement decisions.

In yet another embodiment, the method may further include generating a 2-dimensional or 3-dimensional map of the porous sand volume.

The present invention may also be practiced as a system including a non-transitory data source; a user interface; and at least one computer processor configured to communicate with the non-transitory data source and the user interface and to execute computer modules, the computer modules configured for seismic inversion to produce a p-impedance model and a s-impedance model; sand prediction to estimate sands and shales; regional trend analysis; and porous sand prediction.

The present invention may also be practiced as an article of manufacture a non-transitory computer readable medium having computer readable code on it, the computer readable code being configured to implement a method for characterizing a subsurface reservoir, the method including analyzing the well logs to determine regional trends that differentiate at least two of porous sands, cemented sands, and shales; inverting the seismic data to obtain a p-impedance model and an s-impedance model; determining a gross sand volume from a ratio of the p-impedance model to the s-impedance model and a first depth dependent cutoff; and determining a porous sand volume from the gross sand volume through a second depth dependent cutoff for cemented sand p-impedance values.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, pending claims and accompanying drawings where:

FIG. 1 is a flowchart illustrating a method for performing subsurface reservoir characterization in accordance with an embodiment of the invention;

FIG. 2 shows the P-wave impedance, the P-wave impedance/S-wave impedance ratio, and the depth-dependent cutoff analyzed in an embodiment of the invention for one spatial location;

FIG. 3 is a map of porous sands generated by an embodiment of the invention; and

FIG. 4 is a schematic representation of a system for implementing an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple computer processors, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to estimating hydrocarbon reserves in a subsurface reservoir and, by way of example and not limitation, can be used to determine the location and volume of porous sands in the subsurface. Porous sands contain pore spaces in which hydrocarbons may be found and through which the hydrocarbons may flow.

The inventors have determined that it is possible differentiate between cemented sands, porous sands, and shales based on seismic data and well logs. By determining where porous sands are located and the volume of porous sands, more accurate estimates of locations and volumes of hydrocarbon reserves may be made.

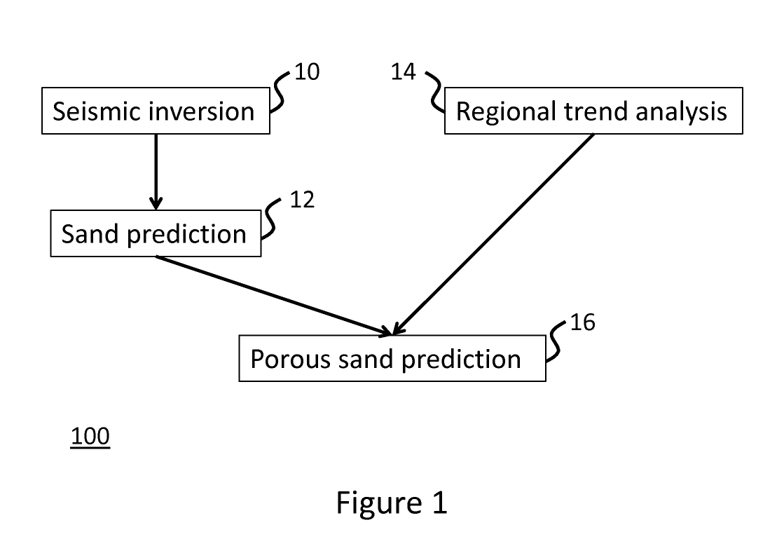

In this regard, an example of a method 100 in accordance with the present invention is illustrated in the flowchart of FIG. 1. The seismic inversion 10 receives seismic data, such as seismic angle gathers, and at least one velocity model, such as a smoothed P-wave velocity model. The seismic inversion produces a P-impedance model and a S-impedance model. There are many options for seismic inversion, including but not limited to constrained sparse spike inversion. An implementation of constrained sparse spike inversion can be performed by Fugro-Jason's InverTrace^{PLUS}. This example of a seismic inversion method is not intended to be limiting; other methods for seismic inversion to calculate P-wave and S-wave impedances are known and fall in the scope of this invention. It is also possible for the seismic inversion to produce P-wave and S-wave velocity models which may be used by the present invention in the same way as the P-wave and S-wave impedances.

Once the P-impedance (IP) and S-impedance (IS) models are calculated at step 10, they can be used at step 12 for sand prediction. The P-wave velocity model is used to estimate the lower frequency (0-5 Hz) signal of both IP and IS models through empirically derived relationships. Higher frequencies (5-30 Hz) for inversion are sourced from the seismic data. The IP/IS ratio and the low-frequency IP model can be used to differentiate between the sand and the shale. The IP/IS ratio, which is equivalent to the ratio of p-wave to shear velocity Vp/Vs, is a direct measure of rigidity. As such, shales tend to remain less rigid than sands regardless of cementation and can be identified. The separation in rigidity between sands and shales changes as IP changes, so the low-frequency IP model may be used to predict IP/IS ranges for sands and shale, allowing the computation of a depth dependent cutoff between sands and shale. This process is executed by the computer. Step 12 can produce a map of the sands and shale in the area of interest but the sands will include both cemented and porous.

Method 100 may also receive regional well logs at step 14 for regional trend analysis. The well logs may include Primary Wave Sonic (VP), Bulk Density (RHOB), and Shear Wave Sonic (VS) and may be measured in boreholes within the area covered by the seismic data or in boreholes within the same geologic region as the area covered by the seismic data. Using the relationships IP=VP*RHOB and IS=VS*RHOB, well log relationships are used to empirically determine regional trends and value cut-offs to differentiate between cemented sands, porous sands, and shales. The resulting rock property catalog can exhibit trends, for example, related to Total Vertical Depth (TVD) or Depth Below Mudline (DBML), which may indicate depth dependent cutoffs for different rock types. This process may be done by a person with computer assistance.

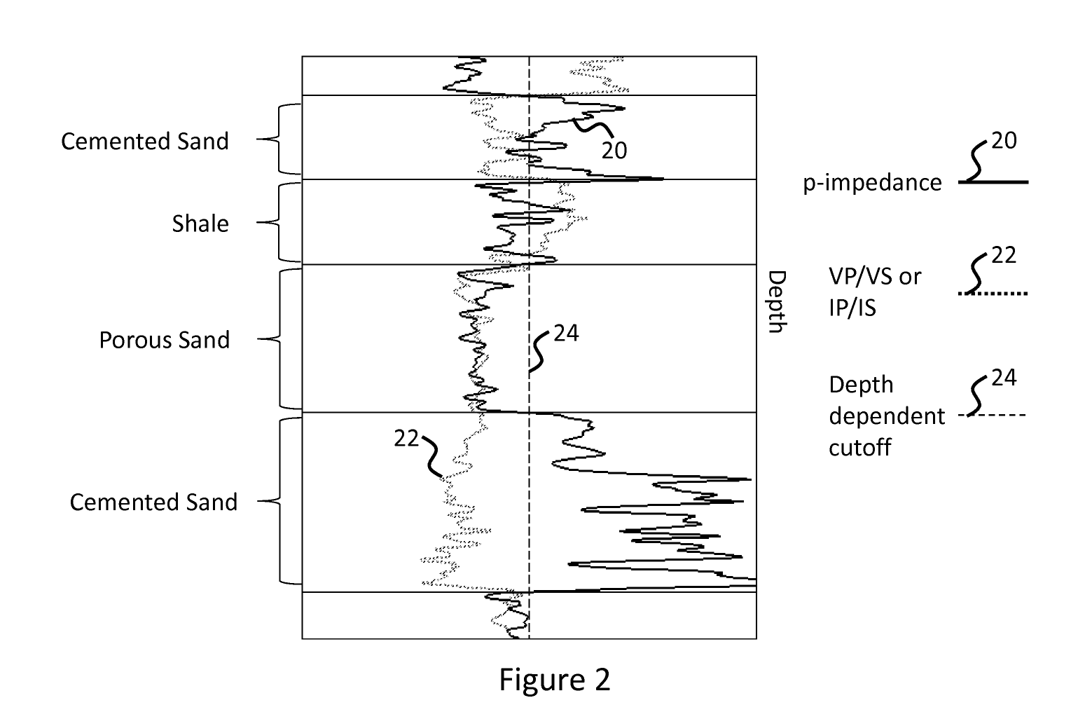

When the sand prediction 12 and the regional trend analysis 14 are completed, their results may be used at step 16 to predict the porous sands. The porous sand prediction may be based on the IP/IS ratio, the IP, and a depth dependent cutoff such as a DBML cutoff. This process may be done by the computer. Cemented sands exhibit significantly higher P-wave velocities and therefore IP than porous sands. An example of the porous sand prediction may be seen in FIG. 2.

In FIG. 2, the intermediate products of this workflow from a single spatial location within the area covered by the seismic data are displayed. The P-impedance 20 from step 10 of FIG. 1 is shown with the IP/IS ratio 22 from step 12 of FIG. 1. The DBML cutoff 24 from step 14 of FIG. 1 is also shown. Based on the behavior of the P-impedance 20 and IP/IS ratio 22 with respect to each other and to the DBML cutoff 24, the porous sand, cemented sand and shale may be determined.

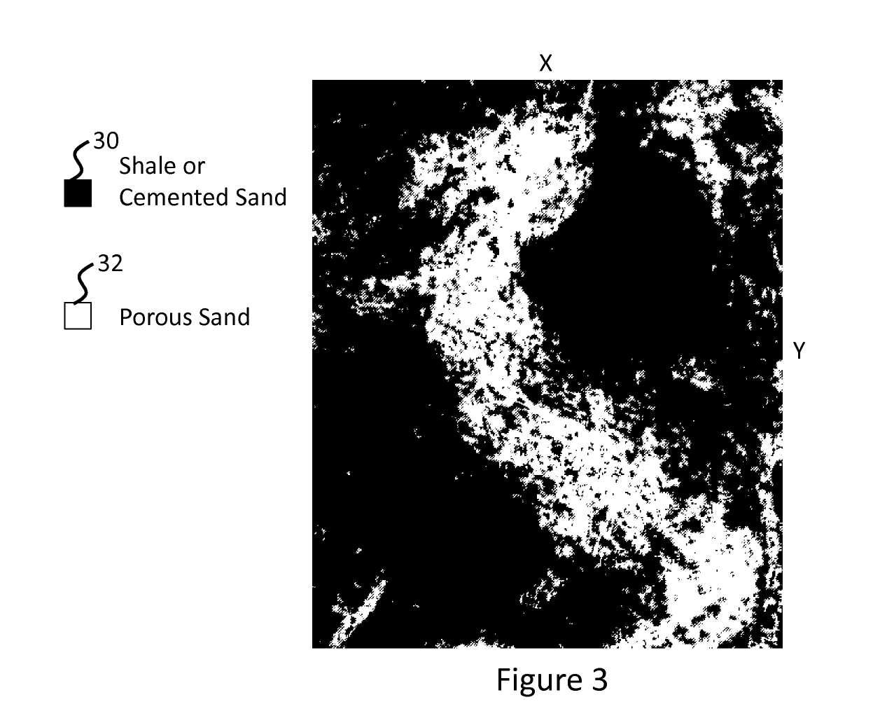

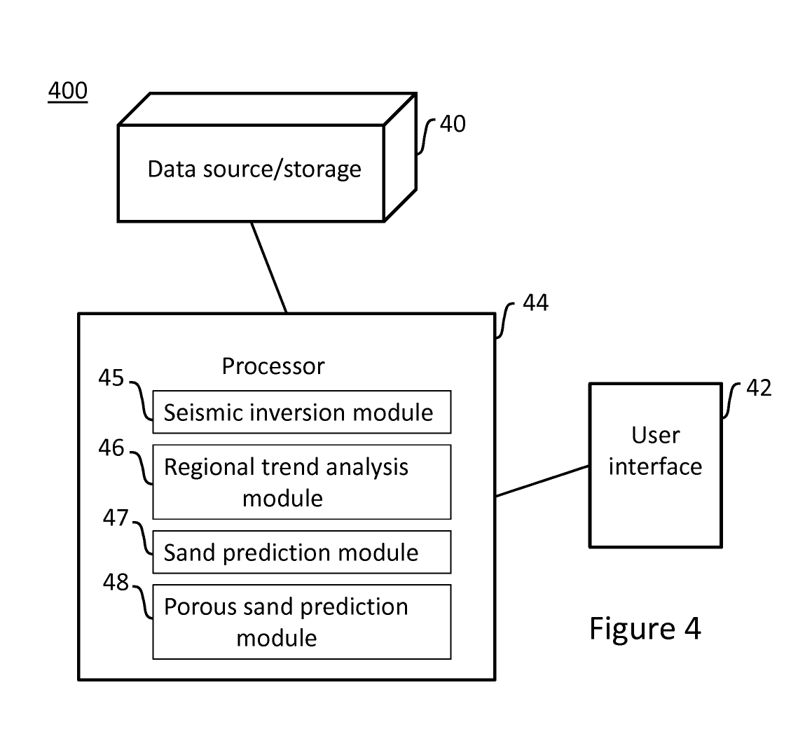

When the porous sand prediction 16 of FIG. 1 has been completed, it is possible to determine porous sands, cemented sands and shales throughout the area covered by the seismic data. With this knowledge, it is then possible to create maps of the porous sands, such as that seen in FIG. 3. In FIG. 3, a 2-D map (coordinates in X and Y) from a single depth slice is shown. The porous sands 32 are shown as white while the cemented sands and shales 30 are shown as black. Although the map in FIG. 4 is 2-D, it is also possible to create 3-D volumes and this also falls within the scope of the present invention.

A system 400 for performing the present invention is schematically illustrated in FIG. 4. The system includes a non-transitory data source and data storage 40 which may contain a recorded seismic dataset and a seismic velocity model. The data source is in communication with the computer processor 44. The processor 44 is configured to receive the data and to execute modules compiled from computer-readable code. These modules may include the seismic inversion module 45, which may be capable of inverting seismic data to obtain a P-wave impedance model (IP) and a S-wave impedance model (IS). The seismic inversion module 45 may also or instead invert seismic data to obtain a P-wave velocity model and a S-wave velocity model. The seismic inversion may be done, for example, by a constrained sparse spike inversion. The modules may also include the regional trend analysis module 46 that analyzes trends in the well logs to determine a depth dependent cutoff, such as a Depth Below Mudline (DBML) cutoff. Another module may be the sand prediction module 47 that uses the output of the seismic inversion module to differentiate between sands and shale. The output from the regional trend analysis module 46 and the sand prediction module 47 may be used by the porous sand prediction module 48 to determine which of the sands are porous. Additional modules might include a mapping module that may produce a 2-D or 3-D map of the porous sands and a hydrocarbon reserve module that might calculate the recoverable hydrocarbons in the porous sand volume. The processor 44 is also in communication with the user interface 42. The user interface 42 may be used both to display data and processed data products and to allow the user to select among options for implementing aspects of the method. The processed data products from processor 44 may be stored on data source/storage 40.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1) A computer-implemented method for characterizing a subsurface reservoir, the method comprising:
a. receiving, at a computer processor, seismic data and at least one migration velocity model representative of the subsurface reservoir and well logs representative of a geologic region similar to the subsurface reservoir;
b. analyzing the well logs to determine regional trends that differentiate at least two of porous sands, cemented sands, and shales;
c. inverting, via a computer processor, the seismic data to obtain a p-impedance model and an s-impedance model;
d. determining, via a computer processor, a gross sand volume from a ratio of the p-impedance model to the s-impedance model and a first depth dependent cutoff; and
e. determining, via a computer processor, a porous sand volume from the gross sand volume through a second depth dependent cutoff for cemented sand p-impedance values, wherein the porous sand volume represents the volume of the subsurface reservoir that may contain recoverable fluids.

2) The method of claim 1, wherein the recoverable fluids are hydrocarbons.

3) The method of claim 2, further comprising using the porous sand volume to calculate hydrocarbon reserves.

4) The method of claim 2, further comprising making well placement decisions.

5) The method of claim 1, further comprising generating a 2-dimensional or 3-dimensional map of the porous sand volume.

6) A system for characterizing a subsurface reservoir, the system comprising:
a. a non-transitory data source;
b. a user interface; and
c. at least one computer processor configured to communicate with the non-transitory data source and the user interface and to execute computer modules, the computer modules configured for:
seismic inversion to produce a p-impedance model and a s-impedance model;
sand prediction to estimate sands and shales;
regional trend analysis; and
porous sand prediction.

7) The system of claim 6, wherein the computer modules are further configured for generating a 2-dimensional or 3-dimensional map of the porous sand volume.

8) The system of claim 6, wherein the computer modules are further configured for using the porous sand volume to calculate hydrocarbon reserves.

9) An article of manufacture including a non-transitory computer readable medium having computer readable code on it, the computer readable code being configured to implement a method for characterizing a subsurface reservoir, the method comprising:
a. analyzing the well logs to determine regional trends that differentiate at least two of porous sands, cemented sands, and shales;
b. inverting the seismic data to obtain a p-impedance model and an s-impedance model;
c. determining a gross sand volume from a ratio of the p-impedance model to the s-impedance model and a first depth dependent cutoff; and
d. determining a porous sand volume from the gross sand volume through a second depth dependent cutoff for cemented sand p-impedance values, wherein the porous sand volume represents the volume of the subsurface reservoir that may contain recoverable fluids.
